(19) United States
(12) Patent Application Publication
(10) Pub. No.: US 2015/0047209 A1
(43) Pub. Date: Feb. 19, 2015

(54) CONSTRAINT FOR A PAIR OF SCISSORS

(71) Applicant: Sarah Schmidt, Stemwede (DE)

(72) Inventor: Sarah Schmidt, Stemwede (DE)

(21) Appl. No.: 14/385,995

(22) PCT Filed: Mar. 5, 2013
(86) PCT No.: PCT/GB2013/050534

§ 371 Date: Sep. 17, 2014

(30) Foreign Application Priority Data
Mar. 19, 2012 (GB) 1204783.3
Dec. 19, 2012 (GB) 1222905.0

(51) Int. Cl. B26B 29/04; B26B 13/22

(52) U.S. Cl. CPC B26B 29/04; B26B 13/22
USPC 30/233

(57) ABSTRACT

A constraint for a pair of scissors is disclosed. The scissors comprise a first and second blade which are arranged to pivot between an open configuration in which the first and second blades are angularly separated about a pivot disposed intermediate a proximal and distal end of the blades, to define a mouth for receiving material to be cut, and a closed configuration in which the first and second blades are substantially aligned to close the mouth. The constraint comprises means arranged to limit the reconfiguration of the blades between the open and closed configurations to provide for a better control of the blades and ensure a smooth cut of the material during use.

The present invention relates to a constraint for a pair of scissors.

Children and people with coordination problems often have difficulty manipulating scissors to suitably cut material, such as a piece of card or paper. It is found that children for example, struggle to maintain a suitable grip within finger rings associated with the scissors, as the blades of the scissors are pivoted with respect to each other. It is also found that children and people with coordination problems such as the elderly and those suffering from medical conditions, are unable to suitably gauge the force required to close the blades of the scissors to cut the material, which results in the material tearing as the distal end of the blades are brought together forcefully within the material.

In accordance with the present invention, there is provided a constraint for a pair of scissors, the scissors comprising a first and second blade which are arranged to pivot between an open configuration in which the first and second blades are angularly separated about a pivot disposed intermediate a proximal and distal end of the blades, to define a mouth for receiving material to be cut, and a closed configuration in which the first and second blades are substantially aligned to close the mouth,
the constraint comprising means arranged to limit the reconfiguration of the blades between the open and closed configurations.

The blades may separately comprise a cutting portion and a handle portion, the cutting portion may be disposed at the distal end of the blades and the handle portion may be disposed at the proximal end of the blades. The handle portion may comprise a finger ring.

Advantageously, the constraint is arranged to limit the angular separation of the blades to restrict the range of motion of the blades. This empowers children and the like with better control over the blades of the scissors and thus provides for a better cut of the material, while providing children with suitable training in the use of scissors.

Preferably, the constraint is arranged to limit the extent to which the first and second blades can pivot to the open configuration, to limit the opening of the mouth.

Preferably, the constraint is arranged to limit the extent to which the first and second blades can pivot to the closed configuration, to prevent the mouth from fully closing.

An inner edge of the cutting portion of each blade may comprise a sharp portion arranged for cutting the material and a blunt portion arranged for gripping the material when the material is in contact therewith. Preferably the sharp portion is disposed at an end of the cutting portion proximal to the pivot and the blunt portion is arranged at an end of the cutting portion distal to the pivot.

It will be appreciated that the portion of the blades that define the mouth of the scissors is dependent upon the configuration of the blades. In the embodiment in which the constraint prevents the mouth from fully closing, there will be a maximally closed configuration in which the mouth is defined only by a distal portion of the blades. Preferably, when the blades are in the maximally closed configuration, the mouth is defined wholly by the blunt portion of the blades. More preferably, when the blades are in the maximally closed configuration, the vertex of the mouth is substantially coincident with a point of transition between the sharp portion and the blunt portion of each blade. In this preferred embodiment, the scissors are adapted to cut the material until the blades are pivoted to the maximally closed configuration in which the constraint prevents the mouth from further closing. At this point, the blunt portion of the blades will be in contact with the material and thus hold the material in place. One advantage of this arrangement is that the user will not lose his position when cutting, thereby facilitating a smooth cut.

Preferably, the constraint comprises a sheath which is arranged to detachably couple with the blades, and which is arranged to receive at least a portion of the first and second blades. The sheath is preferably arranged to extend along at least a portion of the first and second blades and preferably comprises side walls which are arranged to diverge along at least a portion of the length of the sheath.

The blades are preferably arranged to rotate about the pivot within the sheath, such that the side walls of the sheath are arranged to limit the extent to which the blades can reconfigure to the open configuration. In use, the sheath is arranged to locate upon the blades, such that the side walls diverge from a position disposed substantially adjacent the pivot.

Preferably, the side walls of the sheath are arranged to diverge away from a central portion of the sheath along the length thereof toward the proximal and distal end of the blades. In this respect, the side walls of the sheath either side of the central portion are arranged to limit the angular separation of the blades either side of the pivot and thus limit the opening of the mouth of the scissors.

The constraint preferably further comprises an abutment which is arranged to extend from the sheath between the blades, at a position disposed between the pivot and the proximal end of the blades, and which is arranged to contact the blades at the proximal end thereof to prevent the blades from completely reconfiguring to the closed configuration, and thus to prevent the mouth from completely closing. Alternatively, or in addition thereto, the constraint further comprises an abutment disposed upon the blade at the proximal end thereof, which may be rigidly coupled to or formed integrally with the blade of the scissors, or which may be arranged to detachably couple with a blade of the scissors, to prevent the blades from completely reconfiguring to the closed configuration, and thus to prevent the mouth from completely closing.

In an alternative embodiment, the constraint may comprise a formation disposed on the first blade and a complementary slot disposed on the second blade, the complementary slot being arcuate about the pivot and the formation being arranged to move slidingly within the slot as the first and second blades are reconfigured between the open and closed configurations.

As discussed above, a blade may comprise the cutting portion and the handle portion; the formation and slot may be disposed on the cutting portion or may be disposed on the handle portion.

The slot is preferably closed at an outer end thereof, the outer end being defined with respect to the mouth of the scissors. The position of the outer end of the slot is preferably such that when the blades are pivoted towards the open configuration, the formation abuts the outer end of the slot once the blades are opened to a certain maximal angle, thereby limiting the extent to which the first and second blades can pivot to the open configuration to limit the opening of the mouth.

Alternatively, or in addition thereto, the slot is preferably closed at an inner end thereof. The position of the inner end of the slot is preferably such that when the blades are pivoted towards the closed configuration, the formation abuts the inner end of the slot once the blades are closed to a certain minimal angle, thereby limiting the extent to which the first and second blades can pivot to the open configuration to prevent complete closure of the mouth.

The slot may be closed at the inner and outer ends thereof such that the formation is fully constrained within the slot. The positions of the outer and inner ends (i.e. the extent to which the slot extends outwardly and inwardly) may limit the extent to which the first and second blades can pivot to the closed and open configurations respectively.

In accordance with the present invention as seen from a second aspect, there is provided a pair of scissors comprising a first and second blade which are arranged to pivot between an open configuration in which the first and second blades are angularly separated about a pivot disposed intermediate a proximal and distal end of the blades, to define a mouth for receiving material to be cut, and a closed configuration in which the first and second blades are substantially aligned to close the mouth,
the scissors further comprising a constraint arranged to limit the reconfiguration of the blades between the open and closed configurations.

Further features of the scissors of the second aspect, may comprise one or more of the preferred features of the constraint according to the first aspect.

Embodiments of the present invention will now be described by way of example only and with reference to the accompanying drawings, in which:

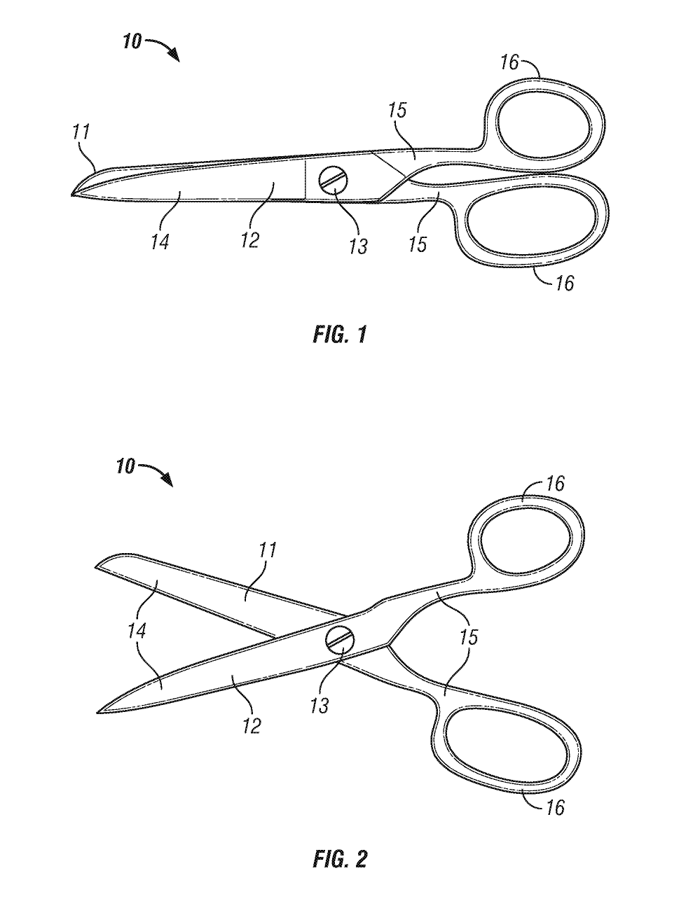

FIG. 1 is a perspective view of a pair of scissors with the blades arranged in a fully closed configuration;

FIG. 2 is a perspective view of a pair of scissors with the blades arranged in an open configuration;

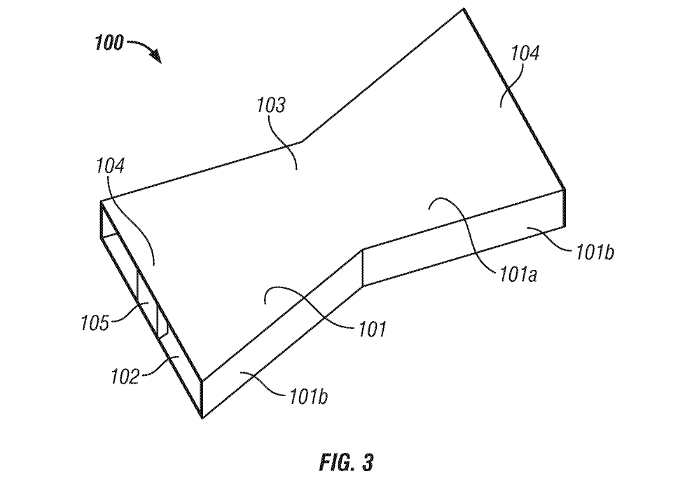

FIG. 3 a perspective view of a constraint according to a first embodiment of the present invention comprising an integral abutment;

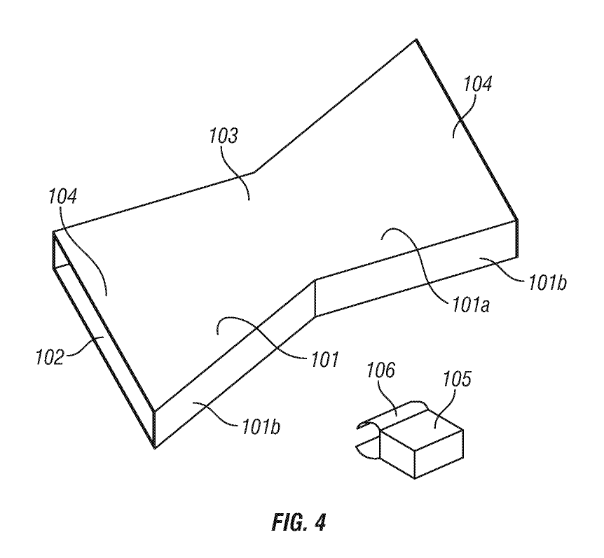

FIG. 4 a perspective view of a constraint according to a second embodiment of the present invention comprising a separate abutment;

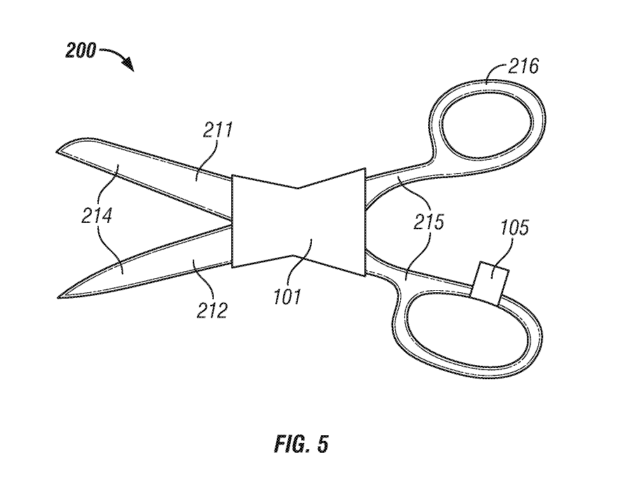

FIG. 5 is a perspective view of a pair of scissors according to an embodiment of the present invention, in an open configuration;

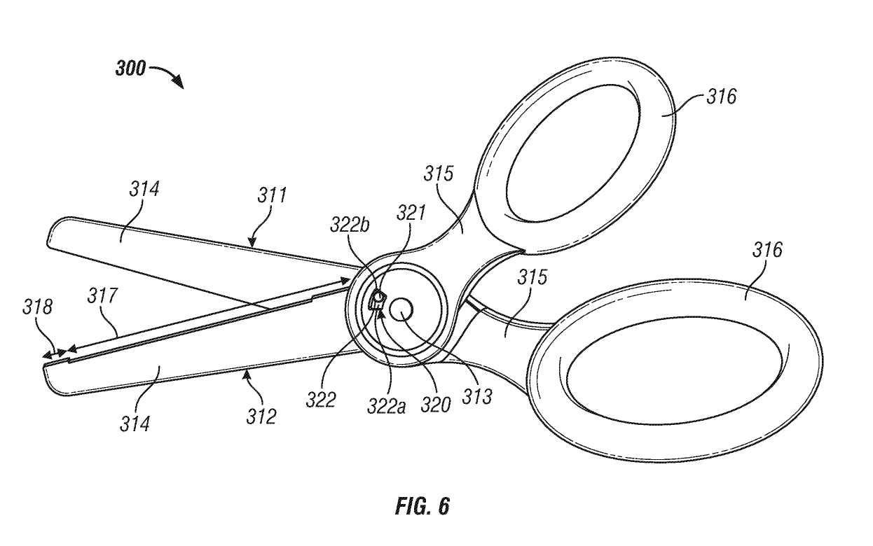

FIG. 6 is a perspective view of a pair of scissors comprising a constraint according to a third embodiment of the present invention; and,

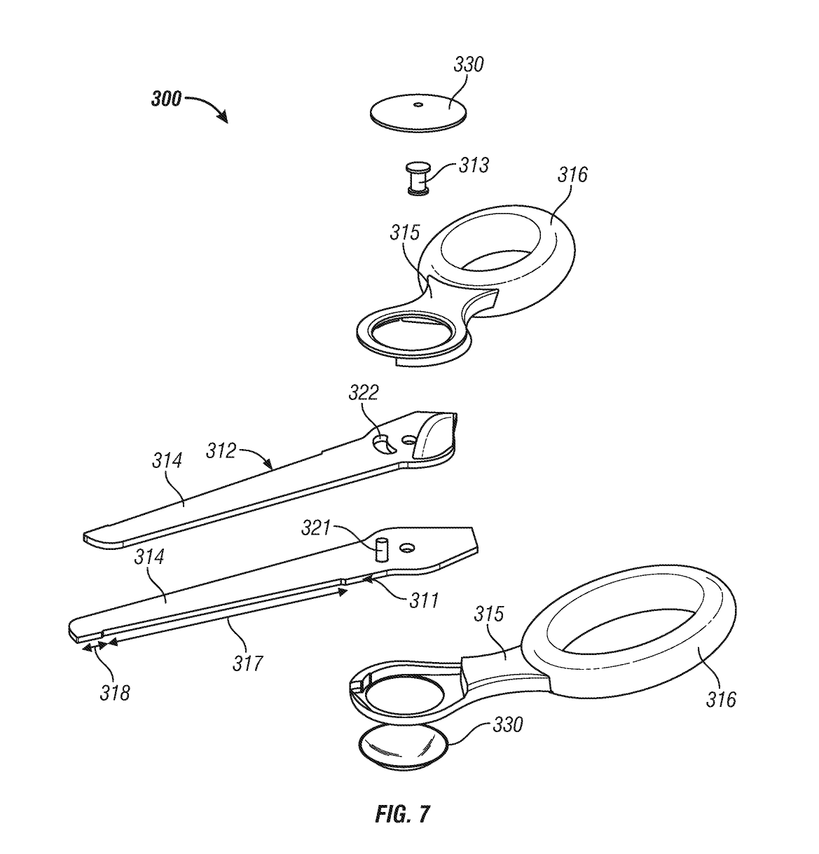

FIG. 7 is an exploded view of the pair of scissors illustrated in FIG. 6.

Referring to FIGS. 1 and 2 of the drawings, there is illustrated a known pair of scissors 10 for cutting various types of material, such as paper, card and fabric (not shown). The scissors 10 comprise a first and second blade 11, 12 which are coupled about a pivot pin 13 which extends through the blades 11, 12 at a position disposed intermediate a proximal and distal end thereof, such that the blades 11, 12 can rotate relative to each other about the pin 13. The blades 11, 12 separately comprise a cutting portion 14 disposed at one side of the pin 13 and a handle portion 15 disposed at the other side of the pin 13. The handle portion 15 of each blade 11, 12 comprises a finger ring 16 disposed at the proximal end thereof which enables an operator (not shown) to grip the blades 11, 12 to suitably manipulate the blades 11, 12 to cause the blades 11, 12 to rotate about the pin 13. In this respect, by rotating the handle portions 15 relative to each other about the pin 13, the cutting portion 14 of the blades 11, 12 can rotate to open and close a mouth defined therebetween to cut material (not shown) disposed therein.

Referring to FIG. 3 of the drawings, there is illustrated a constraint 100 according to a first embodiment of the present invention for limiting the range of motion of the blades 11, 12 of the scissors 10, such as the scissors 10 illustrated in FIGS. 1 and 2 of the drawings, as the blades 11, 12 rotate relative to each other about the pin 13. The constraint 100 is arranged to limit the extent to which the cutting portion 14 of the blades 11, 12 can rotate between an open configuration in which the blades 11, 12 are angularly separated so that the mouth can receive material (not shown) to be cut, and a closed configuration in which the blades 11, 12 are substantially aligned to close the mouth.

The constraint 100 comprises a sheath 101 having a channel 102 formed therein for receiving a portion of the blades 11, 12. In an embodiment of the present invention, the sheath 101 comprises a first and second sheath cover 101a (only the first of which is illustrated in FIG. 3) which are arranged to locate either side of the blades 11, 12 adjacent the pin 13 and detachably couple together. In an alternative embodiment, the sheath 101 may be formed of a resiliently flexible material, such that the sheath 101 may be secured upon the blades 11, 12 by inserting the blades 11, 12 (when arranged in the closed configuration) within the sheath channel 102 and sliding the sheath along the blades to locate proximate the pin.

The sheath channel 102 comprises side walls 101b which are arranged to diverge along the sheath 101 from a central portion 103 thereof, to opposite longitudinal ends 104 of the sheath 101. In this respect, the width of the channel 102 is arranged to increase from the central portion 103 of the sheath 101 to opposite longitudinal ends 104 thereof. The blades 11, 12 are arranged to rotate about the pin 13 relative to each other, within the sheath 101, however, the side walls 101b of the sheath 101 are arranged to limit the angular separation of the cutting portion 14 of the blades 11, 12 to an angle less than 60° and preferably less that 45° and preferably substantially 35°.

The sheath 101 of the first embodiment further comprises an abutment 105, which is arranged to extend between the sheath covers 101a at a proximal end of the blades 11, 12, between the handle portions 15 and is arranged to prevent the handle portions 15 of the blades 11, 12 from touching to prevent the mouth of the blades 11, 12 from completely closing. The abutment 105 may be detachably coupled to one or both of the sheath covers 101a or rigidly coupled to one or both sheath covers 101a, so that the pivot 13 can pass the abutment 105 when sliding the sheath 101 onto the blades 11, 12, for example. Once suitably positioned between the handle portions 15, the abutment 105 is arranged to restrict the minimum angular separation of the cutting portion 14 of the blades to approximately 5°.

In a second embodiment of the constraint 100 of the present invention, as illustrated in FIG. 4 of the drawings, the abutment 105 may alternatively extend from a proximal portion of one or both of the blades 11, 12, such as from a position disposed upon a finger ring 16. The abutment 105 may be detachably couplable to the finger ring 16 using a clip 106 for example, which is arranged to snap-locate to a finger ring 16. Alternatively, the abutment 105 may be rigidly coupled to or formed integrally with the finger ring 16. The abutment 105 is arranged to extend toward the other finger ring 16, within the plane of rotation of the blades 11, 12, such that the abutment 105 is similarly arranged to prevent the proximal end of the blades 11, 12 from touching to prevent the mouth of the cutting portion 14 of the blades 11, 12 from closing.

Referring to FIG. 5 of the drawings, there is illustrated a pair of scissors 200 according to an embodiment of the present invention comprising the constraint 100 according to the above described second embodiment. The scissors 200 comprises the same features as those described above with reference to FIGS. 1 and 2 and so like features have been referenced using the same numerals but increased by 200.

In the embodiment illustrated in FIG. 5, the abutment 105 may be detachably coupled to the finger rings 16 or alternatively rigidly coupled thereto. In use, the sheath 101 limits the angular separation of the blades 211, 212 at the cutting portion 214 to substantially 35° and thus prevents the handle portions 215 from separating to a position which may otherwise reduce an operators (not shown) ability to control the blades 211, 212. Similarly, the abutment 105 disposed upon the finger ring 216 prevents the finger rings 216 from touching, as illustrated in FIG. 1 and thus prevents the distal portion of the blades 211, 212 from becoming aligned to close the mouth. The constraint 100 thus provides a restricted range of motion of the blades 211, 212 about the pivot pin 213 to facilitate a better control of the blades 211, 212 in cutting material (not shown) and ensure a smooth cut of the material.

Referring to FIGS. 6 and 7 of the drawings, there is illustrated a pair of scissors 300 comprising a constraint 320 in accordance with an alternative embodiment of the present invention. The scissors 300 comprises the same features as those described above with reference to FIGS. 1 and 2 and so like features have been referenced using the same numerals but increased by 300. In detail, the scissors 300 comprise first and second blades 311, 312 coupled intermediate their proximal and distal ends about a pivot pin 313 which extends through the blades 311, 312 such that the blades 311, 312 can rotate relative to each other about the pin 313. The blades 311, 312 separately comprise a cutting portion 314 disposed at one side of the pin 313 and a handle portion 315 disposed at the other side of the pin 313. The inner edge of the cutting portion 314 comprises a sharp portion 317 suitable for cutting paper or the like that is inserted in the mouth of the scissors defined between the cutting portions 213 of the blades 311, 312. The inner edge of the cutting portion 314 further comprises a blunt portion 318 suitable for gripping paper or the like when held at the vertex of the mouth defined between the cutting portions 312 of the blades 311, 312. The handle portion 315 of each blade 311, 312 comprises a finger ring 316 disposed at the proximal end thereof. In the illustrated embodiment, the handle portion 315 is formed of a plastics material such as a thermoplastic elastomeric (TPE). However, it will be appreciated that the handle portion 315 may alternatively be formed of a metal or the like, and may be formed integrally with the cutting portion 314. The handle portions 315 enable an operator (not shown) to grip the blades 311, 312 to suitably manipulate the blades 311, 312 to cause the blades 311, 312 to rotate about the pin 313. In this respect, by rotating the handle portions 315 relative to each other about the pin 313, the cutting portion 314 of the blades 311, 312 can rotate to open and close the mouth defined therebetween.

In the embodiment illustrated in FIGS. 6 and 7, the constraint 320 comprises a formation 321 in the form of a cylindrical lug disposed on the first blade 311. The formation 321 is formed integrally with the cutting portion 314 of the first blade 311.

The constraint further comprises a complementary slot 322 disposed on the second blade 312. The slot 322 defines an arc of a circle centred on the pin 313, which defines the pivot of the blades 311, 312. The radius of the circle i.e. the perpendicular distance between a point on the arc and the pin 313 is less than half of the width of the first blade 311 at the location of the pin 313 such that the slot 322 remains in contact with a portion of the first blade 311 throughout the angular range of motion of the blades 311, 312. The width of the slot is such that the formation 321 fits closely within the slot 322 but is able to move slidingly along the arcuate length thereof.

The slot 322 is bounded at its inner and outer ends 322a, 322b such that the formation 321 is constrained within the slot 322. The length of the slot 322, namely the arcuate distance between the inner and outer ends 322a, 322b may be chosen in accordance with the desired angular range of movement of the blades 311, 312.

The extent to which the blades 311, 312 are able to pivot inwardly and outwardly to close and open the mouth is constrained by the interaction of the slot 322 and formation 311. For example, the extent to which the blades 311, 312 are able to open is limited by the position of the outer end 322b of the slot 322: once the formation 321 abuts the outer end 322b of the slot 322 then the formation 321 is unable to move outwardly beyond this point and hence the blades 311, 312 are constrained from further opening. This maximally open configuration is illustrated in FIG. 6. Similarly, the extent to which the blades 311, 312 are able to close is limited by the position of the inner end 322a of the slot 322: once the formation 321 abuts the inner end 322a of the slot 322 then the formation 321 is prevented from moving further inwardly and hence the blades 311, 312 are constrained from further closing.

In use, as a user pivots the blades from the maximally open configuration towards the closed configuration, the sharp portions 317 of the blades 311, 312 act to cut the material at the apex of the mouth. However, once the blades 311, 312 reach the maximally closed configuration, the mouth is defined wholly by the blunt portions 318 of the blades 311, 312. In this respect, the material is held in position between the blunt potions 318 of the blades 311, 312 when the blades 311, 312, thereby enabling the user to easily maintain his position whilst cutting and alleviating any risk of injury whilst the blades 311, 312 are in the maximally closed configuration.

It will be appreciated, however, that the scissors 300 may be designed such that the position of the inner end 322a does not limit the extent to which the blades 311, 312 may close. For example, the inner end 322a of the slot 322 may be disposed sufficiently inwardly of the second blade 312 such that the blades 311, 312 are instead prevented from fully closing by abutment of the finger rings 316 of the handle portions 315. In this embodiment, the blades 311, 312 are able to close fully, the constraint 320 acting only to limit the opening of the blades 311, 312. Similarly, the scissors 300 may be designed such that the position of the outer end 322b does not limit the extent to which the blades 311, 312 may open. In this embodiment, the constraint 320 acts only to limit the closing of the blades 311, 312.

In an alternative embodiment (not shown), the slot may be open at either the inner end 322a or the outer end 322b such that the formation 321 is able to move out of the slot when the blades 311, 312 are in the fully closed and fully open configurations respectively. Accordingly, in this embodiment, the constraint is adapted for constraining the blades 311, 312 from fully closing or fully opening but not constraining the blades 311, 312 from both fully opening and fully closing.

Furthermore, whilst features such as the sharp portions 317 and blunt portions 318 of the blades 311, 312 have been described with respect to the embodiment illustrated in FIGS. 6 and 7, it will be appreciated that such features may equally apply to other embodiments of the present invention.

1. A constraint for a pair of scissors, the scissors comprising a first and second blade which are arranged to pivot between an open configuration in which the first and second blades are angularly separated about a pivot disposed intermediate a proximal and distal end of the blades, to define a mouth for receiving material to be cut, and a closed configuration in which the first and second blades are substantially aligned to close the mouth,
wherein the means is arranged to limit the extent to which the first and second blades can pivot to the open configuration, to limit the opening of the mouth, the means being further arranged to limit the extent to which the first and second blades can pivot to the closed configuration, thereby defining a maximally closed configuration in which the mouth is not fully closed.

2. A constraint according to claim 1, wherein the first and second blades separately comprise a cutting portion disposed at a distal end of the respective blade and a handle portion disposed at a proximal end of the respective blade.

3. A constraint according to claim 1, wherein the handle portion of each blade comprises a finger ring.

4. A constraint according to claim 2, wherein an inner edge of the cutting portion of each blade comprises a sharp portion arranged for cutting the material and a blunt portion arranged for gripping the material when the material is in contact therewith, the sharp portion being disposed at a proximal end of the cutting portion and the blunt portion being arranged at a distal end of the cutting portion.

5. A constraint according to claim 4, wherein the mouth of the scissors in the maximally closed configuration is bounded only by the blunt portions of the blades and not the sharp portions of the blades.

6. A constraint according to claim 1, wherein the means comprises a sheath which is arranged to detachably couple with the blades, and which is arranged to receive at least a portion of the first and second blades.

7. A constraint according to claim 6, wherein the sheath is arranged to extend along at least a portion of the first and second blades.

8. A constraint according to any of claim 6, wherein the sheath further comprises side walls which are arranged to diverge along at least a portion of the length of the sheath.

9. A constraint according to claim 6, wherein the blades are arranged to rotate about the pivot within the sheath.

10. A constraint according to claim 8, wherein the side walls of the sheath further are arranged to diverge away from a central portion of the sheath along the length thereof toward the proximal and distal end of the blades.

11. A constraint according to claim 6, further comprising an abutment which is arranged to extend from the sheath between the blades, at a position disposed between the pivot and the proximal end of the blades, and which is arranged to contact the blades at the proximal end thereof to prevent the blades from completely reconfiguring to the closed configuration, and thus to prevent the mouth from completely closing.

12. A constraint according to claim 6, wherein the constraint comprises or further comprises an abutment disposed upon the blade of the scissors at a proximal end thereof, and which is arranged to prevent the blades from completely reconfiguring to the closed configuration, and thus to prevent the mouth from completely closing.

13. A constraint according to claim 1, the constraint comprising a formation disposed on the first blade and a complementary slot disposed on the second blade, the complementary slot being arcuate about the pivot and the formation being arranged to move slidingly within the slot as the blades are reconfigured between the open and closed configurations.

14. A constraint according to claim 13 wherein the slot is closed at an outer end of the arcuate length thereof such that the constraint acts to limit the extent to which the blades can pivot to the open configuration.

15. A constraint according to claim 13, wherein the slot is closed to an inner end of the arcuate length thereof such that the constraint acts to limit the extent to which the blades can pivot to the closed configuration.

16. A pair of scissors comprising a first and second blade which are arranged to pivot between an open configuration in which the first and second blades are angularly separated about a pivot disposed intermediate a proximal and distal end of the blades, to define a mouth for receiving material to be cut, and a closed configuration in which the first and second blades are substantially aligned to close the mouth,
the scissors further comprising a constraint according to claim 1.

17. A pair of scissors as claimed in claim 16, wherein the first and second blades separately comprise a cutting portion disposed at a distal end of the respective blade and a handle portion disposed at a proximal end of the respective blade, an inner edge of the cutting portion of each blade comprising a sharp portion arranged for cutting the material and a blunt portion arranged for gripping the material when the material is in contact therewith, the sharp portion being disposed at a proximal end of the cutting portion and the blunt portion being arranged at a distal end of the cutting portion.

18. A pair of scissors as claimed in claim 17,
wherein the mouth of the scissors in the maximally closed configuration is bounded only by the blunt portions of the blades and not the sharp portions of the blades.
